(19) United States
(12) Patent Application Publication
(10) Pub. No.: US 2021/0342831 A1
(43) Pub. Date: Nov. 4, 2021

(54) METHOD OF OPERATING ELECTRONIC DEVICE PROVIDING TRANSACTION SERVICE FOR ITEMS IN GAME

(71) Applicant: NEXON KOREA CORPORATION, Seongnam-si (KR)

(72) Inventors: Hye Ra JEONG, Seongnam-si (KR); Ah Reum BAEK, Seongnam-si (KR); Soo Yeon PARK, Seongnam-si (KR)

(21) Appl. No.: 17/243,369

(22) Filed: Apr. 28, 2021

(30) Foreign Application Priority Data
Apr. 29, 2020 (KR) 10-2020-0052888

(51) Int. Cl. G06Q 20/40; G06Q 30/02; A63F 13/35

(52) U.S. Cl. CPC G06Q 20/401; A63F 13/35; G06Q 30/0206

(57) ABSTRACT

A method of operating an electronic device includes: executing a market providing a transaction service which enables trading of items of a first game; based on status information on a first user in the first game, displaying a first execution screen through which at least one item of the first game is purchasable; receiving an input for selecting a first item through the first execution screen or an execution screen generated based on the first execution screen; and when an input for purchasing the first item is received, purchasing the first item.

### CROSS-REFERENCE TO RELATED APPLICATION

This application is based on and claims priority under 35 U.S.C. § 119 to Korean Patent Application No. 10-2020-0052888, filed on Apr. 29, 2020, in the Korean Intellectual Property Office, the disclosure of which is incorporated by reference herein in its entirety.

### BACKGROUND

### 1. Field

One or more embodiments relate to a method of operating an electronic device that provides a transaction service for items in a game.

### 2. Description of the Related Art

Users may play an online game by installing a game program on user devices including various wired and wireless communication devices such as personal computers, smartphones, and tablet PCs. The number of users who enjoy games in various places using mobile communication devices other than PCs has increased.

In addition, transactions between users for trading game items have also increased. Therefore, techniques are needed to provide services promoting item trading between users.

### SUMMARY

One or more embodiments enable users to smoothly search for desired items, and provide results of the search for the desired items.

One or more embodiments provide a transaction environment for promoting item trading between users.

One or more embodiments provide detailed information on items which users want.

Additional aspects will be set forth in part in the description which follows and, in part, will be apparent from the description, or may be learned by practice of the presented embodiments of the disclosure.

According to one or more embodiments, a method of operating an electronic device includes: executing a market providing a transaction service which enables trading of items of a first game; based on status information on a first user in the first game, displaying a first execution screen through which at least one item of the first game is purchasable; receiving an input for selecting a first item through the first execution screen or an execution screen generated based on the first execution screen; and when an input for purchasing the first item is received, purchasing the first item.

According to one or more embodiments, a computer program is stored in a non-transitory medium for executing the method.

According to one or more embodiments, a non-transitory computer-readable recording medium having recorded thereon a program for executing the method.

According to one or more embodiments, an electronic device includes: a communication device; a user interface device; a processor; and a memory storing instructions executable by the processor, wherein the processor executes the instructions to: execute a market providing a transaction service which enables trading of items of a first game; display a first execution screen, through which at least one item of the first game is purchasable, on the user interface device based on status information on a first user in the first game; receive, through the user interface device, an input for selecting a first item on the first execution screen or an execution screen generated based on the first execution screen; and purchase the first item when an input for purchasing the first item is received through the user interface device.

### BRIEF DESCRIPTION OF THE DRAWINGS

The above and other aspects, features, and advantages of certain embodiments of the disclosure will be more apparent from the following description taken in conjunction with the accompanying drawings.

The present disclosure may be easily understood by the following description in conjunction with the accompanying drawings, and reference numerals refer to structural elements.

FIG. 1 is a view illustrating an online game providing system including a server and clients according to an embodiment;

FIG. 2A is a flowchart illustrating a method of operating an electronic device in which a market providing a transaction service for game items is executed, according to an example embodiment;

FIG. 2B is a flowchart illustrating a method of operating the electronic device in which the market providing a transaction service for game items is executed, according to another embodiment;

FIG. 3 is a view illustrating an execution screen through which game items may be purchased based on a user's status information, according to an example embodiment;

FIG. 4 is a view illustrating an execution screen on which a list of items found by search based on a user's status information is shown, according to an embodiment;

FIG. 5 is a view illustrating a process of searching for items based on an input for calling up search criterion information, according to an embodiment;

FIG. 6A is a view illustrating an execution screen which displays detailed information on a selected item, according to an embodiment;

FIG. 6B is a view illustrating an execution screen which displays information on the market price of a selected item, according to an embodiment;

FIG. 6C is a view illustrating an execution screen which shows comparison between a selected item and another item, according to an example embodiment;

FIG. 6D is a view illustrating a process of purchasing a selected item, according to an embodiment;

FIG. 7A is a view illustrating a process of inputting a search word to search for items, according to an example embodiment;

FIG. 7B is a view illustrating an execution screen for setting a search condition for searching for items, according to an example embodiment;

FIG. 7C is a view illustrating an execution screen for setting a search condition for searching for items, according to another embodiment;

FIG. 8A is a view illustrating an execution screen showing a sales interface for selling items, according to an example embodiment;

FIG. 8B is a view illustrating an item of which the sale period has expired and items waiting for sale among sale items, according to an example embodiment;

FIG. 8C is a view illustrating a process of purchasing a registration slot in which an item may be registered, according to an example embodiment;

FIG. 8D is a view illustrating a process of preselling an item, according to an embodiment;

FIG. 9A is a view illustrating an execution screen showing items registered by a user as items of interest, according to an embodiment;

FIG. 9B is a view illustrating a process in which a user compares items selected from items of interest, according to an example embodiment;

FIG. 9C is a view illustrating a process of comparing an item that a user possesses with an item of interest of the user, according to an embodiment;

FIG. 9D is a view illustrating results of comparison between an item that a user possesses and an item of interest of the user, according to an example embodiment;

FIG. 9E is a view illustrating a process of purchasing an item of interest that has been previewed, according to an example embodiment; and

FIG. 10 is a block diagram illustrating a configuration of an electronic device according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Various embodiments will now be described with reference to the accompanying drawings. The embodiments described below may be variously modified. In the following description, those well-known to those of ordinary skill in the art will not be described in detail for more clear descriptions of embodiments.

Moreover, in the present specification, when a portion or element is referred to as being “connected” to another portion or element, the portion or element may be “directly connected” to the other portion or element, or may be connected to the other portion or element “with intervening portions or elements being therebetween.” In addition, it will be further understood that the terms “comprises” and/or “comprising” used herein specify the presence of stated features or elements, but do not preclude the presence or addition of one or more other features or elements.

In addition, although terms such as “first” and “second” are used to describe various elements, these elements should not be limited by these terms. These terms are only used to distinguish one element from another element.

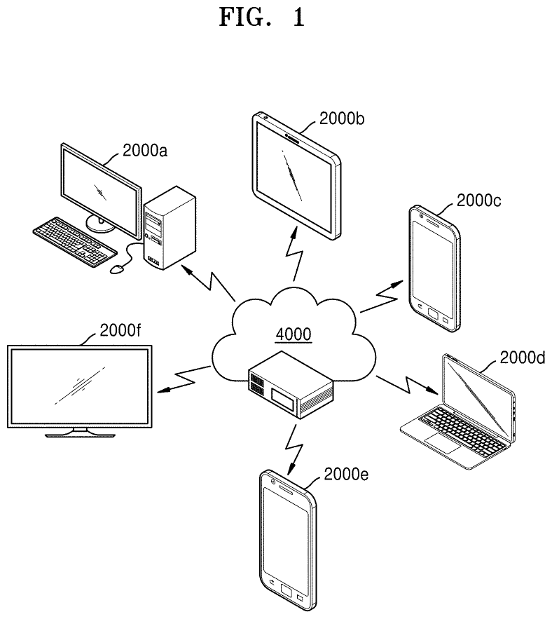

FIG. 1 is a view illustrating an online game providing system including a server and clients according to an embodiment.

According to an embodiment, as shown in FIG. 1, the online game providing system may include a server 4000 and a plurality of clients 2000a, 2000b, 2000c, 2000d, 2000e, and 2000f. The server 4000 may provide a game to the clients 2000a, 2000b, 2000c, 2000d, 2000e, and 2000f through a network.

Although FIG. 1 shows a desktop computer, a tablet, a mobile phone, a laptop computer, a smartphone, and a television as examples of the clients 2000a, 2000b, 2000c, 2000d, 2000e, and 2000f, which are used by users, the clients 2000a, 2000b, 2000c, 2000d, 2000e, and 2000f are not limited thereto and may include various electronic devices such as personal digital assistants (PDAs), portable multimedia players (PMPs), navigations, MP3 players, digital cameras, refrigerators, washing machines, and vacuum cleaners.

A game (for example, an online game) may be executed on the clients 2000a, 2000b, 2000c, 2000d, 2000e, and 2000f. A program for executing the game, such as an application or a launcher, may be installed on the clients 2000a, 2000b, 2000c, 2000d, 2000e, and 2000f, but embodiments are not limited thereto. Users may enjoy the game provided by the server 4000 by executing the program installed on the clients 2000a, 2000b, 2000c, 2000d, 2000e, and 2000f. Various embodiments described later may be implemented in the program for executing the game or may be implemented in a program separate from the program.

The server 4000 may be operated by a game provider and may include, but is not limited thereto, a stand-alone server, a group of servers, and a cloud server. The server 4000 may provide the game to users and may include a database for storing user data. In addition, the server 4000 may further include a payment server or a settlement server for generating and processing payment events. The payment server or the settlement server may be a server separate from the server 4000 and may mediate payment or settlement between the server 4000 and the clients 2000a, 2000b, 2000c, 2000d, 2000e, and 2000f. The server 4000 may further include a database (DB) server that stores and manages user data, and the DB server may be a server separate from the server 4000.

A program for servicing the game may be executed on the server 4000. Various embodiments described later may be implemented in the program for servicing the game, or may be implemented in a program separate from the program.

The network may refer to a connection established (or formed) according to a communication method, such as a communication network connected through a communication means for transferring data between the clients 2000a, 2000b, 2000c, 2000d, 2000e, and 2000f or between the server 4000 and the clients 2000a, 2000b, 2000c, 2000d, 2000e, and 2000f.

Examples of the communication means may include communication means using a predetermined communication standard, frequency band, protocol, or channel, short-range communication means, telecommunication means, wireless communication means, and wired communication means. Examples of the communication means may include Bluetooth, Bluetooth low energy (BLE), wireless fidelity (Wi-Fi), Zigbee, 3G, long term evolution (LTE), and ultrasonic-wave communication means, but are not limited thereto.

The short-range communication means may refer to means, such as Bluetooth and near field communication (NFC) means, which enables communication between devices only when the devices are located within a given range, but embodiments are not limited thereto.

The telecommunication means may refer to a communication means enabling communication between devices regardless of the distance between the devices. Examples of the telecommunication means may include a communication means which enables communication between two devices through a repeater such as an access point (AP) even when the distance between the two devices is greater than a certain range, and a communication means using a cellular network such as 3G and LET networks, which are used for text message transmission and phone calls. However, examples of the telecommunication means are not limited thereto.

When the server 4000 provides an online game through a network, the server 4000 and the clients 2000a, 2000b, 2000c, 2000d, 2000e, and 2000f may communicate with each other through an arbitrary communication means.

Examples of the online game may include a role playing game (RPG), a tabletop RPG (TRPG), a massively multiplayer online RPG (MMORPG), multiplayer online battle arena (MOBA), Aeon of Strife (AOS), real time strategy (RTS), first-person shooter (FPS), a trading card game (TCG), a collectible card game (CCG), sport games, and fighting games, but are not limited thereto. The online game may be played as a match between users or a match between a user and a computer (for example, artificial intelligence), but is not limited thereto and may be implemented in various forms.

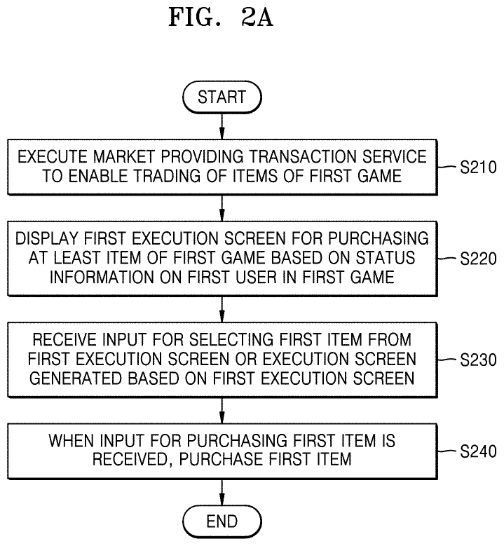

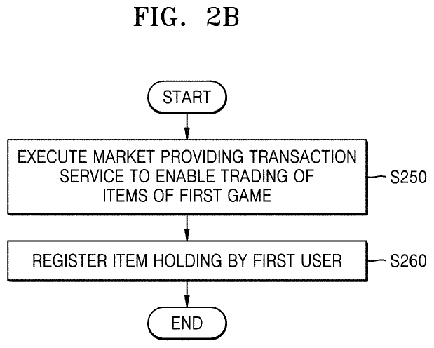

The online game providing system illustrated in FIG. 1 may also function as an online platform providing system. In addition, the clients 2000a, 2000b, 2000c, 2000d, 2000e, and 2000f shown in FIG. 1 may correspond to an electronic device 10 described with reference to FIGS. 2A to 10.

FIG. 2A is a flowchart illustrating a method of operating the electronic device 10 on which a market providing a transaction service for game items is executed, according to an example embodiment.

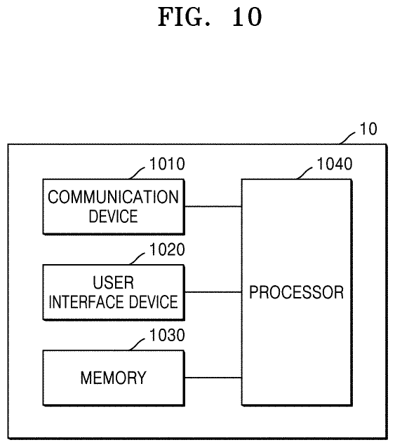

Referring to FIG. 2A, in operation S210, the electronic device 10 (refer to FIG. 10) may execute a market that provides a transaction service for trading of items of a first game.

For example, the “market” may be a system provided to allow a user to purchase or sell items of the first game. Through the market, users may buy and sell items that are used in a game. For example, a program or application corresponding to the market may be installed on the electronic device 10, and when the program or application is executed on the electronic device 10, users may trade items through the market. The program or application corresponding to the market may be distributed through a server.

In addition, the program or application corresponding to the market may be executed independently of a program or application corresponding to the first game. In addition, information on a first event that occurred in the market may be transmitted to the server that manages the first game. The server, which manages the first game, may transmit information on the first event that occurred in the market to the electronic device 10, which executes the first game, and may provide an environment reflecting the first event to the first game. In addition, information on a second event that occurred in the first game may be transmitted to the server that manages the market. The server, which manages the market, may transmit the information on the second event that occurred in the first game to the electronic device 10, which executes the first game, and may provide an environment reflecting the second event to the market.

That is, because an event that occurred in the market is linked to the first game, status information on a first user may be updated in the first game. In addition, because an event that occurred in the first game is linked to the market, status information on the first user may be updated in the market.

For example, the term “item” may refer to an article, a product, content, or the like that may be used in a game. For example, items may refer to equipment, auxiliary equipment, accessories, coordination, or consumables such as weapons, armor, or costumes which may be put on a game character.

In operation S220, the electronic device 10 may display a first execution screen through which at least one item of the first game may be purchased, based on status information on the first user in the first game.

For example, when the market is executed on the electronic device 10, the electronic device 10 may obtain status information on the first user from the server that manages the first game. The electronic device 10 may display the first execution screen which contains a list of at least one item corresponding to the status information on the first user.

For example, the status information on the first user may include at least one selected from the group consisting of a first character played by the first user in the first game, the level of the first user in the first game, the quest of the first user in the first game, and the game progress status of the first user in the first game.

For example, based on the first character played by the first user and the level of the first user, the electronic device 10 may search for items available for the first character and the level of the first user and may display the first execution screen including a list of found items.

For example, the electronic device 10 may display an interface through which at least one entry, which corresponds to the status information on the first user and is considered in searching for particular items of the first game, is selectable. The electronic device 10 may display the first execution screen based on a first entry selected from the at least one entry.

For example, the electronic device 10 may display a first button indicating the first character played by the first user in the first game, a second button indicating the level of the first user, a third button indicating the quest of the first user, and a fourth button indicating a hunting ground in the first game on which the first user plays the first game. The electronic device 10 may receive an input of selecting the first button and the third button among the first to fourth buttons. The electronic device 10 may search for items necessary for the first character of the first user to accomplish the quest of the first user, and may display the first execution screen including a list of found items.

For example, the electronic device 10 may receive an input for calling up a first search criterion among a plurality of search criteria which define at least one selected from the group consisting of a condition for searching for items of the first user's interest and a condition for sorting results of the search. The electronic device 10 may display a list in which one or more items are rearranged based on the first search criterion.

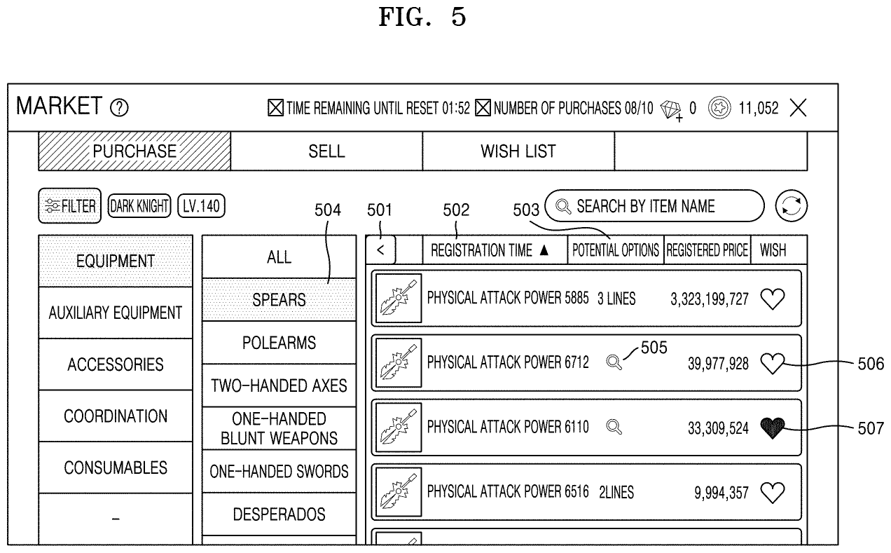

For example, the plurality of search criteria may be stored in advance in the account of the first user. In addition, a history of search criteria may also be stored. When the market is executed with the account of the first user, the electronic device 10 may receive an input for calling up the first search criterion among the plurality of search criteria. For example, a predetermined search criterion may be called up when a user presses a button corresponding to the predetermined search criterion or enters an input corresponding to the predetermined search criterion. For example, a touch may be set as an input for calling up the first search criterion, and two consecutive touches may be set as an input for calling up a second search criterion. A process, in which items in a list are rearranged in response to calling-up of a search criterion, will be described later with reference to FIG. 5.

For example, the electronic device 10 may search for items based on a called-up search criterion and may display a list of found items. In addition, the electronic device 10 may determine the order of priority of previously found items based on the called-up search criterion, and may display a list in which the items are rearranged according to the order of priority.

For example, the electronic device 10 may display the first execution screen that contains a list of one or more items arranged based on the status information on the first user. Here, the list may include information on the suitability of each of the one or more items for the first user.

For example, when the first user plays the first game on a first hunting ground using the first character, the electronic device 10 may search for items in the market based on the first hunting ground. The electronic device 10 may display a list in which items are arranged based on the first character. Here, when there is a second item in the list that cannot be put on the first character, the electronic device 10 may display information indicating that the second item cannot be put on the first character. In addition, the items in the list may be sorted based on the order of suitability of the items for the first character.

In operation S230, the electronic device 10 may receive an input for selecting the first item from the first execution screen or a screen generated based on the first execution screen.

For example, the electronic device 10 may receive the first search criterion which defines at least one selected from the group consisting of a condition for searching for items of interest on the first execution screen and a condition for sorting search results on the first execution screen. The electronic device 10 may display a first search result obtained based on the first search criterion. The electronic device 10 may receive an input for selecting the first item from the first search result.

For example, a condition for searching for an item of interest may define at least one selected from the group consisting of a user's character, a user's level, a category of the item of interest, and the price of the item of interest. In addition, a condition for sorting search results may define at least one parameter, based on which the priority of the item of interest is determined. For example, the at least one parameter may include the attack power, defense ability, or price of the item of interest.

In addition, the electronic device 10 may display a second execution screen which contains an interface providing information on the price of the first item and information on comparison between items. The electronic device 10 may receive an input for selecting price information or comparison information from the second execution screen. The electronic device 10 may display detailed information on the first item based on an input for selecting price information or comparison information.

In addition, the electronic device 10 may compare an item which the first user possesses with an item of the first user's interest and may display results of the comparison. For example, the item of the first user's interest may be an item stored in a wish list or a shopping cart. In addition, the item of the first user's interest may be an item selected by the first user. For example, the item which the first user possesses and the item of the first user's interest may be compared with each other in at least one comparison entry selected from the group consisting of physical attack power, accuracy rate, damage increase rate, and use period. The electronic device 10 may display results of comparison between the item that the first user possesses and the item of the first user's interest in terms of the at least one comparison entry.

In addition, when the selected first item is an expired or sold-out item, the electronic device 10 may display a second item as a substitute for the first item based on the status information on the first user. For example, an item, which has the same function as the first item and can be put on the first character of the first user, may be determined as a substitute for the first item. However, an item, which has the same function as the first item but cannot be put on the first character of the first user, may not be determined as a substitute for the first item. In addition, when there are a plurality of items that can be substituted for the first item, the electronic device 10 may arrange and display the plurality of substitute items based on a predetermined criterion for arranging a plurality of items.

In operation S240, when the electronic device 10 receives an input for purchasing the first item, the electronic device 10 may purchase the first item.

For example, the electronic device 10 may display a purchase interface through which at least one selected from previewed items of interest may be purchased. For example, the electronic device 10 may receive an input for selecting the first item through the purchase interface, and may perform an operation of purchasing the first item. After the first item is purchased with the account of the first user through the market, the first user may possess the first item in the first game through a linkage between the market and the first game.

In addition, when it is determined that the difference between options of a first holding item which the first user possesses and options of a first interest item in which the first user is interested is greater than a predetermined criterion, the electronic device 10 may guide purchasing of the first interest item. Here, the first interest item and the first holding item may belong to the same category.

FIG. 2B is a flowchart illustrating a method of operating the electronic device 10 on which a market providing a transaction service for game items is executed, according to another embodiment.

Referring to FIG. 2B, in operation S250, the electronic device 10 may execute a market that provides a transaction service for trading of items of the first game.

In operation S260, the electronic device 10 may receive an input for registering an item that the first user possesses and may register the item with the market.

For example, the electronic device 10 may display a sales interface through which items may be registered. The electronic device 10 may receive an input for registering an item through the sales interface and may register the item with the market. For example, the input for registering an item may be an input of information about the period of time for selling the item, the price of the item, the number of units of the item for sale, etc.

For example, the electronic device 10 may provide a sales interface for selling an item, based on at least one selected from the group consisting of the sales performance of the first user and the status information on the first user.

For example, when the first item registered by the first user has been sold 20 or more times and the first item is added to an item-storing inventory that the first user possesses, the electronic device 10 may display, as the market is executed, a message inquiring whether to register the first item.

For example, the electronic device 10 may display a sales interface in which an allowable registration range is adjusted for the first user based on the sales performance of the first user. For example, as the sales performance of the first user increases, the number of registration slots allocated to the first user may increase. For example, when the ratio of actually sold items to registered items exceeds 60%, the number of registration slots allocated to the first user may be increased.

For example, when all registration slots for selling items are in use, the electronic device 10 may guide the first user to purchase additional registration slots.

For example, the electronic device 10 may guide the first user through a sales interface in order to sell an item of which the frequency of use is lower than a predetermined criterion. For example, the electronic device 10 may guide the first user to sell an item among items of the first user which has not been used three or more times while the first user accesses the first game ten times. The electronic device 10 may detect a low-frequency item that has not been used three or more times during the last 10 accesses to the first game, and may display a message inquiring whether to register the low-frequency item with the market. When the electronic device 10 receives a command to register the low-frequency item with the market, the electronic device 10 may register the low-frequency item as an item for sale (sale item).

For example, the electronic device 10 may guide the first user to sell a certain item through the sales interface based on the status information on the market and the status information on the first user. For example, when the demand for equipment having a first function rapidly increases in the market and the first user has equipment having the first function, the electronic device 10 may display a message inquiring about the possession of a first piece of equipment having the first function and about the selling of the first piece of equipment. When the electronic device 10 receives a command to register the first piece of equipment with the market, the electronic device 10 may register the first piece of equipment as an item for sale. Alternatively, the electronic device 10 may automatically register the first piece of equipment having the first function with the market.

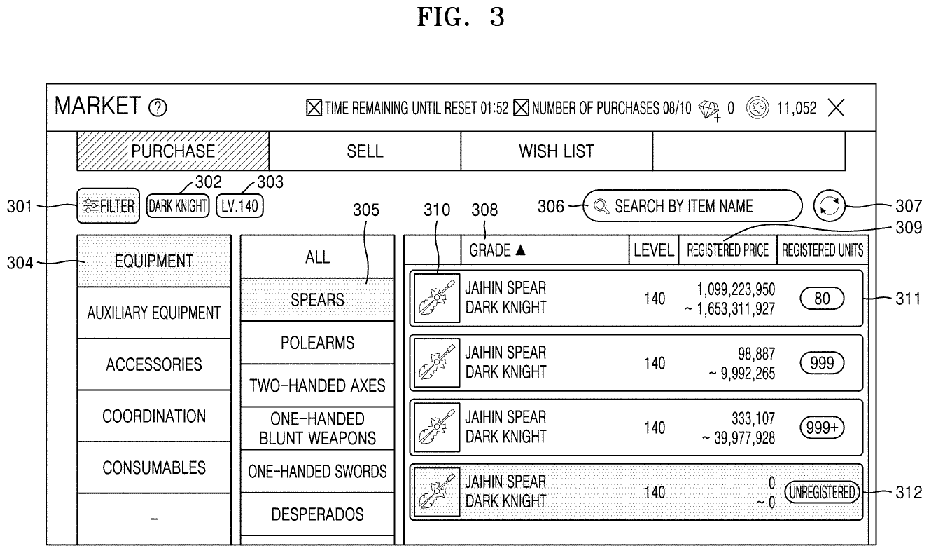

FIG. 3 is a view illustrating an execution screen through which game items may be purchased based on a user's status information, according to an example embodiment.

FIG. 3 illustrates an execution screen which is displayed when a market is executed on the electronic device 10. For example, the market may provide: a purchase interface through which a user input may be received such that a user may purchase game items; a sales interface through which a user input may be received such that a user may sell game items; and a wish list interface through which a user input may be received such that a user may manage items of interest.

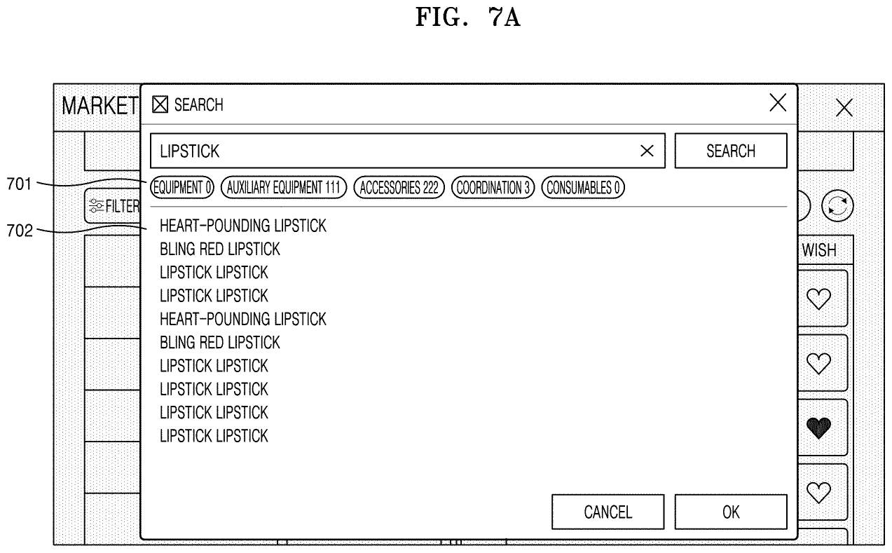

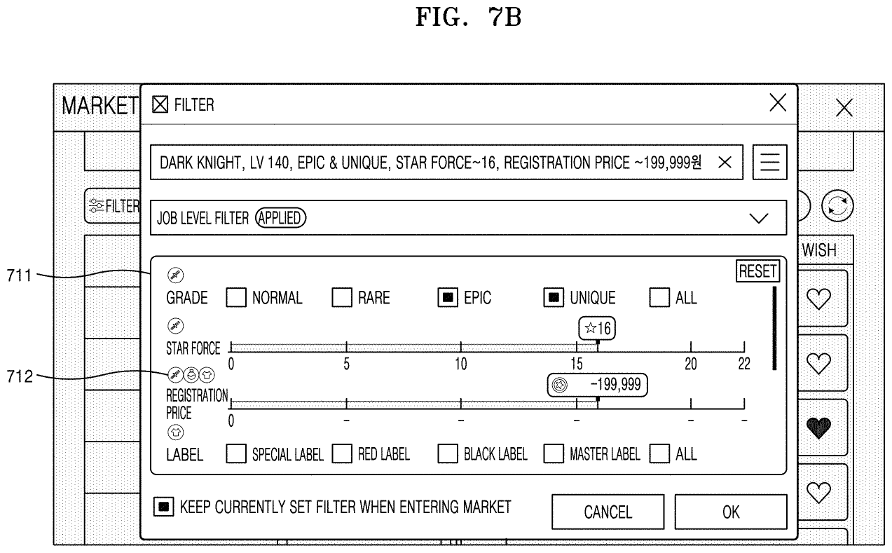

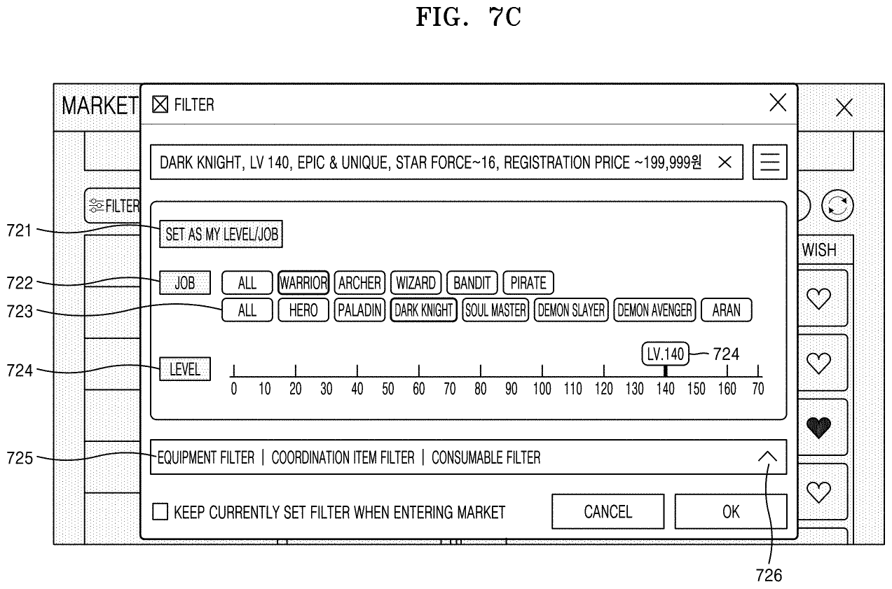

Referring to FIG. 3, the market may provide a filter button 301. When the filter button 301 is selected, a filter setting screen for setting an item search condition or a condition for sorting search results may be displayed. The filter setting screen will be described later with reference to FIGS. 7B and 7C.

In addition, the market may provide buttons 302 and 303 for selecting entries corresponding to a user's status information such that items may be searched for by considering the user's status information. For example, an entry corresponding to the user's status information may include at least one selected from the group consisting of a user's character, a user's level, a user's quest, and a user's stage in the progress of a game. Referring to FIG. 3, the market may display the button 302 for selecting the character of the first user and the button 303 for selecting the level of the first user.

In addition, the buttons 301, 302, and 303 may be provided as objects on the execution screen. Therefore, when an input of selecting a button is received, a function corresponding to the button may be activated.

For example, when a search is performed in a state in which the button 302 and the button 303 are selected, the market may search for and display items suitable for level—140 Dark Knight. In addition, when the market is executed, items may be searched for in a state in which the button 302 and the button 303 are automatically selected.

The market may provide parent entries and child entries of the parent entries. As shown in FIG. 3, the parent entries may include an equipment entry 304, an auxiliary equipment entry, an accessory entry, a coordination entry, and a consumable entry. In addition, when the equipment entry 304 is selected, child entries of the equipment entry 304 may be displayed. In addition, when a spear entry 305 is selected from the child entries of the equipment entry 304, a list of items corresponding to the spear entry 305 may be displayed.

In addition, the market may provide a search bar 306 through which search words may be input. The search bar 306 will be described later with reference to FIG. 7A. In addition, the market may provide a refresh button 307. When a user presses the refresh button 307, updated search results may be displayed.

Referring to FIG. 3, a list of items found by the search may include: image information 310 on the items; the names of the items; information 308 on the grades of items; information on the levels of the items; information 309 on the registered prices of the items; and information 311 and 312 on the numbers of registered units of the items.

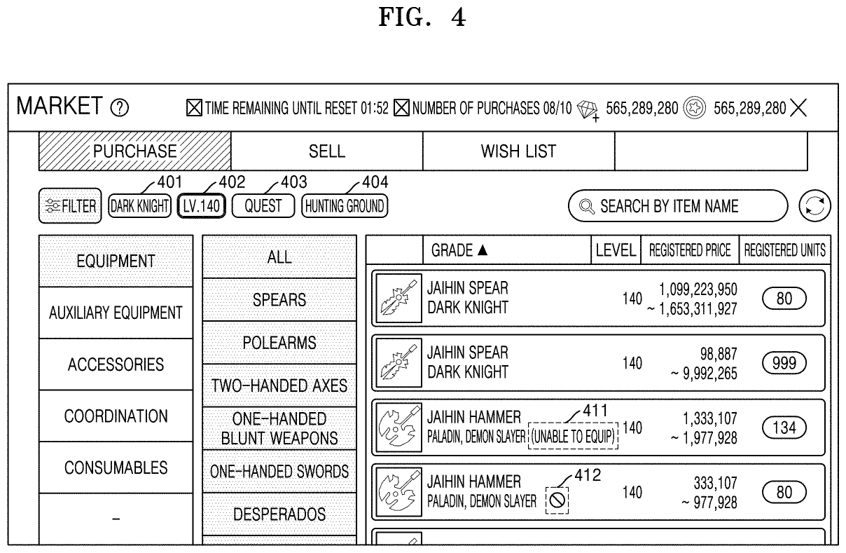

FIG. 4 is a view illustrating an execution screen on which a list of items found by search based on a user's status information is shown, according to an embodiment.

Referring to FIG. 4, the market may provide buttons 401, 402, 403, and 404 for selecting entries corresponding to a user's status information such that items may be searched for by considering the user's status information.

For example, the market may display the button 401 for selecting the first character of the first user, the button 402 for selecting the level of the first user, the button 403 for selecting the quest for the first user, and the button 404 for selecting a hunting ground on which the first user plays the first game.

When only the button 402 for selecting the level of the first user is selected among the buttons 401, 402, 403, and 404, the market may display a list of items searched for based on the level 140 of the first user.

For example, when only an equipment entry is selected, the market may display an item list by searching for all child entries of the equipment entry. As shown in FIG. 4, the item list may include items that cannot be put on Dark Knight, which is a character of the first user. For example, Jaihin Hammer may be put on Paladin and Demon Slayer, but may not be put on Dark Knight. Information 411 and 412 indicating that Dark Knight, a character of the first user, cannot be equipped with Jaihin Hammer may be displayed on the item list. For example, the information 411 and 412 may be displayed as a text phrase or an image.

FIG. 5 is a view illustrating a process of searching for items based on an input for calling up search criterion information, according to an embodiment.

Referring to FIG. 5, when items are searched in a state in which an equipment entry item and a spear entry 504 are selected, the market may provide a list of items corresponding to the spear entry 504.

The market may provide buttons 502, 503, and 508 that are used to rearrange the items of the list according to given criteria. For example, when the first user touches the button 502 once, the list may be displayed with the items being arranged in the reverse chronological order of registration. In addition, when the first user touches the button 502 twice, the list may be displayed with the items being arranged in the chronological order of registration.

For example, when the first user touches the button 503 once, the list may be displayed with the items being arranged in the descending order of the number of potential options which the items have. When the first user touches the button 503 twice, the list may be displayed with the items being arranged in the ascending order of the number of potential options which the items have. When the first user selects the potential options of a certain item, information on the potential options may be displayed. Further, an icon 505 indicates a disabled state of options.

For example, the button 508 may be used to search for and display items according to a search criterion which is preset by a user. For example, when a user touches the button 508 once, the items of the list may be sorted according to a first search criterion. For example, the first search criterion may be information on conditions for searching for items corresponding to a user's character and a user's level.

In addition, when a user touches the button 508 twice, the items of the list may be sorted according to a second search criterion. For example, the second search criterion may be information on conditions for searching for items corresponding to the level of a user and a hunting ground on which the user plays. For example, when the user's level is 30 and the hunting ground is Gold Beach, the items of the list may be arranged in the descending order of suitability for a level 30 character to hunt on Gold Beach.

In addition, an icon for registering an item in the list as an item of interest may be displayed. For example, when an input of selecting an icon 507 is received, an item having physical attack power of 6110 may be registered as an item of interest. As illustrated in FIG. 5, when an input of selecting the icon 507 is received, the icon 507 may be displayed differently from an icon 506 indicating a non-selected item. For example, when an input of selecting the icon 507 is received, the icon 507 may be displayed in a predetermined color.

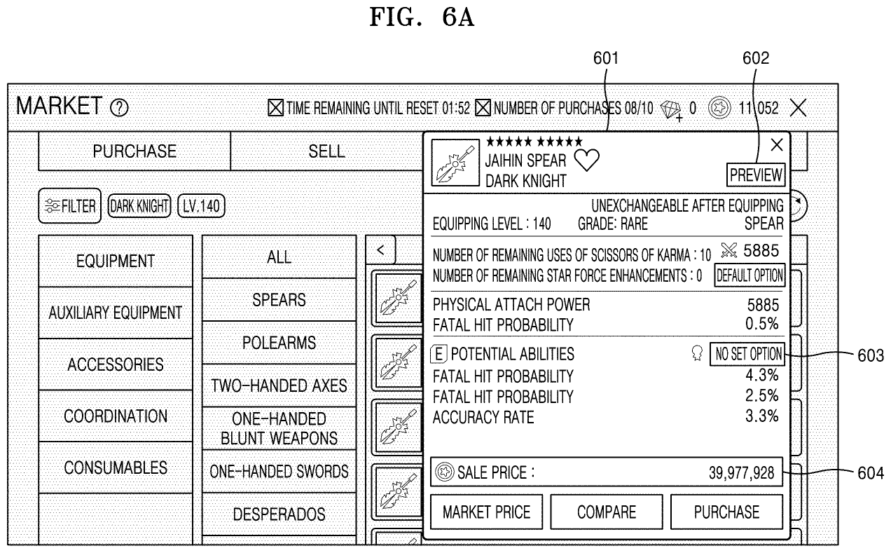

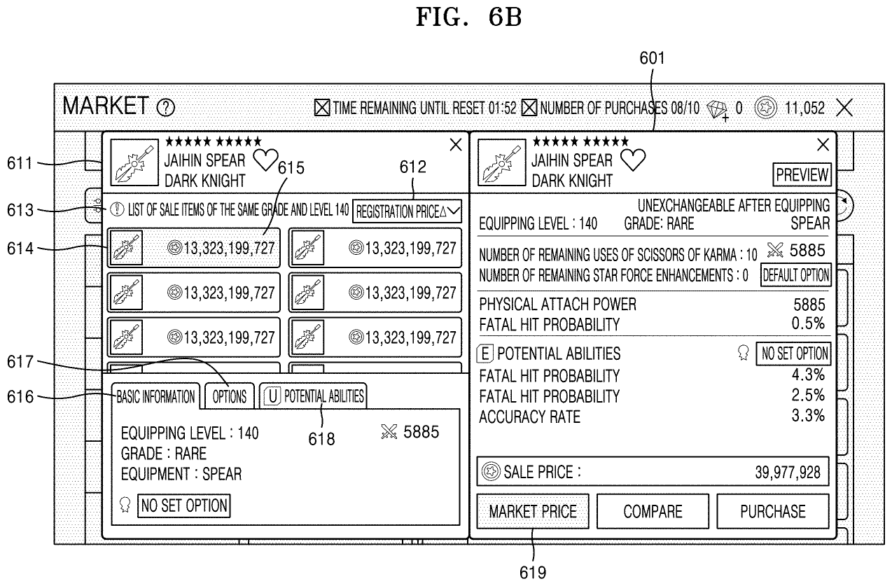

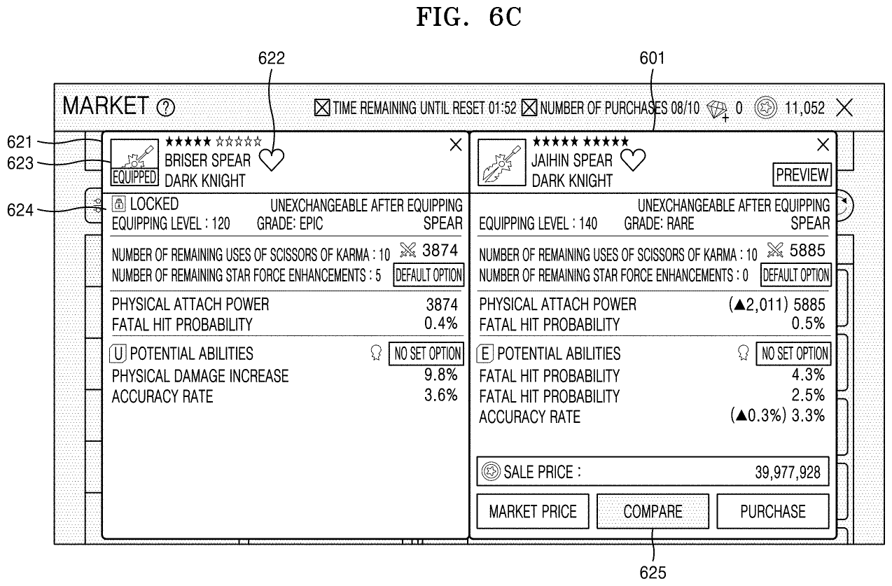

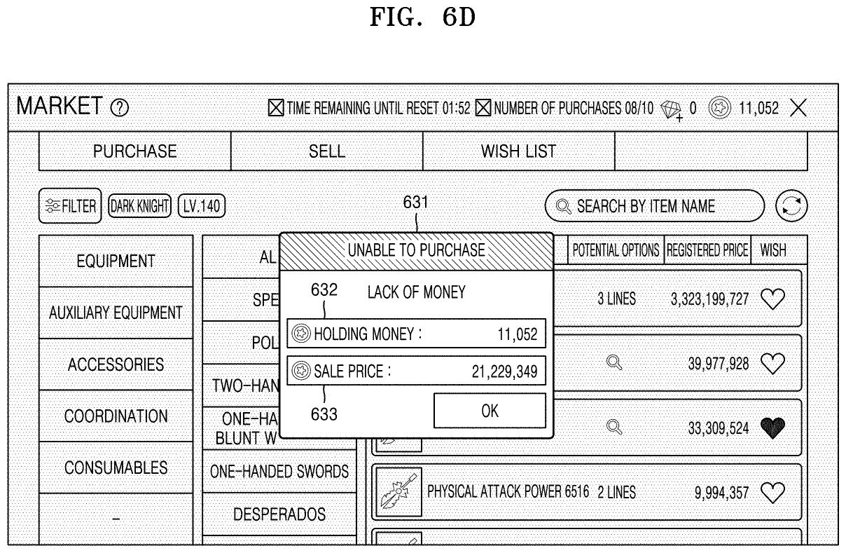

FIG. 6A is a view illustrating an execution screen 601 displaying detailed information on a selected item, according to an embodiment.

Referring to FIG. 6A, when an item is selected from a list of items, the execution screen 601 including detailed information on the selected item may be displayed. For example, the equipment level, grade, and name of the selected item may be displayed on the execution screen 601. In addition, information on the physical attack power and potential abilities of the selected item may be displayed on the execution screen 601.

In addition, when an input of pressing a preview button 602 is received, a figure of a character of the first user equipped with the selected item may be displayed. On the execution screen 601, a button 603 indicating the state of set options may also be displayed. In addition, information 604 on the sale price of the selected item may also be displayed. For example, when the money that the first user has is less than the sale price of the selected item, information indicating lack of money may be displayed. For example, when the money that the first user has is less than the sale price of the selected item, the sale price may be displayed in a second color changed from a first color.

In addition, a button for checking market price information, a button for comparing a selected item with other items, and a button for purchasing a selected item may be displayed on the execution screen 601.

FIG. 6B is a view illustrating the execution screen 601 which displays information on the market price of a selected item, according to an embodiment.

Referring to FIG. 6B, when a button 619 for checking market price information is selected on the execution screen 601, which contains detailed information of an item, an execution screen 611 containing information on the market price of the item may be displayed. For example, the execution screen 611 may be displayed on a side of the execution screen 601.

For example, a list of items for sale which have the same grade as a selected first item 614 and are for level 140 may be displayed on the execution screen 611. The sale item list may show the registered prices of the items. In addition, the sale item list may also show information 613 indicating that the listed items have the same grade as the selected first item 614 and are for level 140. In addition, the items in the sale item list may be sorted according to a predetermined sorting criterion. A button 612 for setting the sorting criterion may be provided. For example, the button 612 for setting the sorting criterion may be for sorting items according to the registered prices of the items.

When the first item 614 is selected from the sale item list, the execution screen 611 may display a tab 616 providing basic information on the first item 614 selected from the sale item list, a tab 617 providing information on options of the first item 614, and a tab 618 providing information on potential abilities of the first item 614.

FIG. 6C is a view illustrating the execution screen 601 which shows comparison between a selected item and another item, according to an example embodiment.

Referring to FIG. 6C, when a button 625 for comparing a selected item with a holding item (an item which a user possesses) is selected on the execution screen 601 containing detailed information on the selected item, an execution screen 621 may be displayed to show detailed information on the holding item with which a user's first character is equipped.

For example, the equipment level, grade, and name of the holding item may be displayed on the execution screen 621, and information on the physical attack power and potential abilities of the holding item may also be displayed on the execution screen 621.

For example, the execution screen 621 may display information such as information 622 indicating whether the holding item is registered in a wish list, information 623 indicating whether the first character is equipped with the holding item, information 624 indicating whether the holding item is locked with respect to the first character.

In addition, the execution screen 601 may display information about comparison between the holding item and the selected item. For example, numerical information on results of comparison in physical attack power or in accuracy rate among potential abilities may be displayed. For example, an increase or decrease in numerical value may be expressed with an exact value or in a percentage.

FIG. 6D is a view illustrating a process of purchasing a selected item, according to an embodiment.

For example, the first user may press a purchase button to purchase a first item on a list of items. Referring to FIG. 6D, when holding money that the first user has is less than the sale price of the first item, a message 631 indicating that the first item cannot be purchased may be displayed. The message 631 may show information 632 on the holding money and information 633 on the sale price.

FIG. 7A is a view illustrating a process of inputting a search word for searching for items, according to an example embodiment.

The market may provide a search bar through which a search word may be input. Referring to FIG. 7A, the first user may enter a search word “lipstick” in the search bar. When the search word “lipstick” is input, information 701 on the number of possible search results may be displayed for each item entry. Item entries may be displayed as parent entries. In addition, when a first parent entry is selected, information on the number of possible search results may be displayed for each child entry of the first parent entry.

For example, with regard to the search word “lipstick,” the number of items of an equipment entry may be displayed as 0, the number of items of an auxiliary equipment entry may be displayed as 111, the number of items of an accessory entry may be displayed as 222, the number of items of a coordination entry may be displayed as 3, and the number of items of a consumable entry may be displayed as 0. For example, when the first user selects an icon corresponding to the auxiliary equipment entry, a list of items, which are related to “lipstick” and are registered in the auxiliary equipment entry, may be displayed.

In addition, information 702 on search words related to the search word “lipstick” may also be displayed. For example, when the first user selects a related search word from the related search words, search results may be displayed based on the selected related search word.

FIG. 7B is a view illustrating an execution screen for setting a search condition for searching for items, according to an example embodiment.

Referring to FIG. 7B, the market may provide an execution screen for setting a search condition for searching for items. For example, the market may provide a detailed filter window 711 for an item. For example, on the detailed filter window 711 for an item, a user may set a condition such as the grade of the item, the Star Force number of the item, the registered price of the item, or the type of label of the item.

For example, the first user may select the grade of the item as Epic or Unique, set the Star Force number of the item to 16, and set the registered price of the item to 199,999 in cash. In addition, the first user may set a registered price for each item entry. An icon 712 may be displayed for an entry of which the registered price range is set.

In addition, a button may be provided such that when entering the market, the search condition, which is set on the filter window 711, may be applied using the button.

FIG. 7C is a view illustrating an execution screen for setting a search condition for search for items, according to another embodiment.

Referring to FIG. 7C, the market may provide an execution screen for setting a search condition for searching for items. For example, the market may provide a filter window for setting a level or job. As shown in FIG. 7C, a button 721 may be provided to set the level/occupation of a user as a search condition. For example, when the button 721 is selected, information on the level of the first user and the job of a character of the first user in the first game may be obtained, and the level of the first user and the job of the character of the first user may be set as search conditions.

In addition, with regard to a job 722, which is a search criterion, the market may provide icons for setting search conditions for the job 722. For example, icons for upper-classification jobs may be displayed. The upper-classification jobs may include warrior, archer, wizard, thief, pirate, etc., but are not limited thereto. In addition, icons for lower-classification jobs may be displayed. For example, the first user may select warrior as a high-classification job and set Dark Knight as a lower-classification job.

In addition, with regard to a level 724, which is a search criterion, the market may provide a level adjustment slide bar for setting a level search condition. For example, the first user may set the level to 140 by adjusting the level adjustment slide bar.

When the level or job setting is completed, the first user may select a detailed filter window 725 for an item and may set a condition such as the grade of the item, the Star Force number of the item, the registered price of the item, and the type of label of the item.

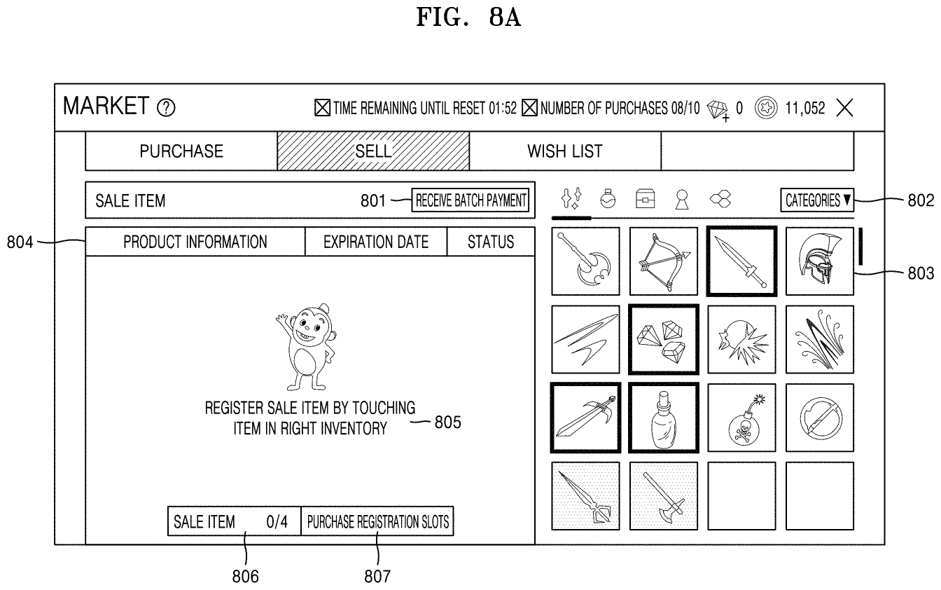

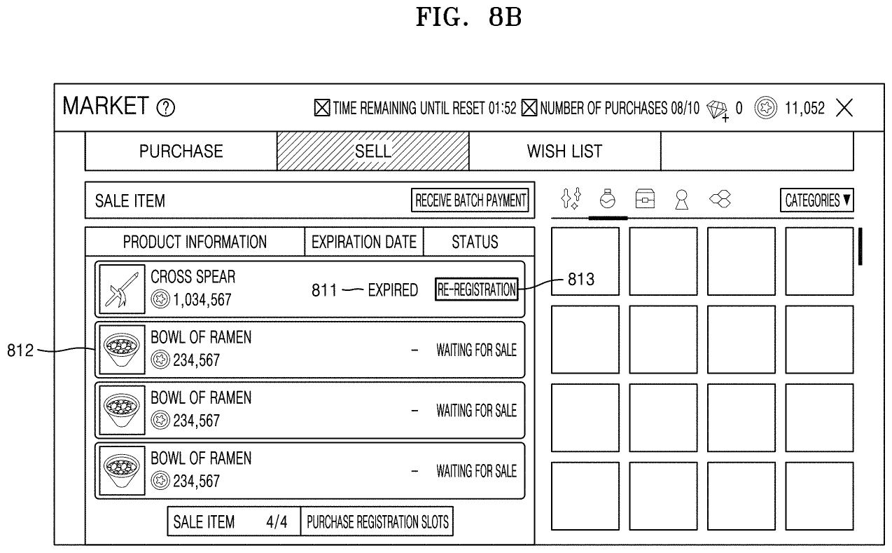

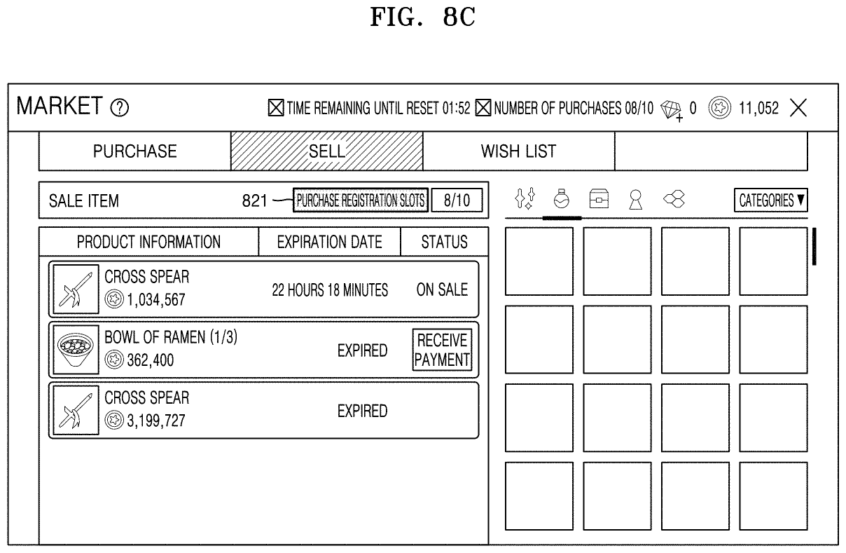

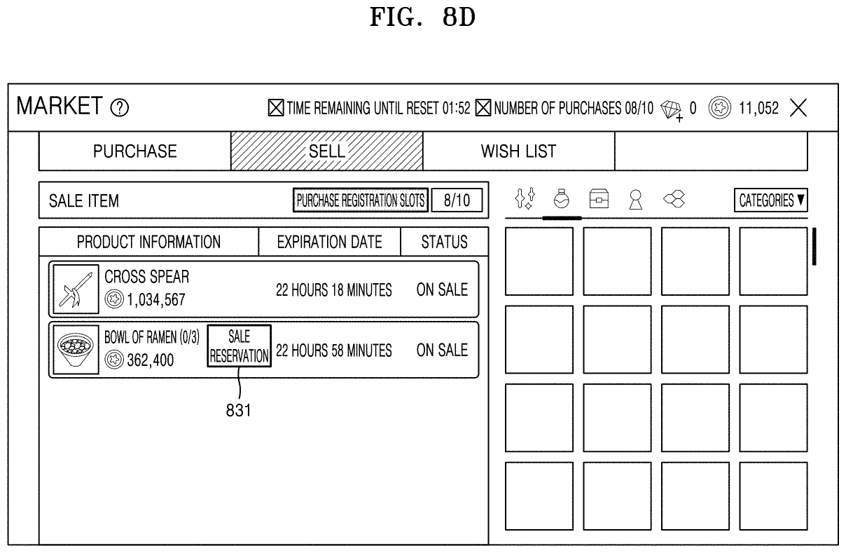

FIG. 8A is a view illustrating an execution screen showing a sales interface for selling items, according to an example embodiment.

When the market is executed on the electronic device 10, a purchase interface may be provided to receive a user input such that a user may purchase game items, a sales interface may be provided to receive a user input such that a user may sell game items, and a wish list interface may be provided to receive a user input such that a user may manage items of interest.

Referring to FIG. 8A, when the first user presses a sales tab, the sales interface may be displayed. The sales interface may provide: a button 801 for collectively receiving payments for sold items; a button 802 for selecting an item category when selecting an item; a list 803 of items included in the selected item category; information 804 on a sale item to be registered for sale; information 806 on holding slots for the sale item; a button 807 for purchasing registration slots which are required when registering the sale item; and the like.

In FIGS. 8A to 8D, a box required for registering a sale item is termed a registration slot, but another term may be used therefor. For example, the term “sale slot” may be used instead of the term “registration slot.”

For example, the information 804 on a sale item may include the product information of the sale item, the expiration date of the sale item, and status information on the sale item. The product information of the sale item may include an image of the sale item, the product name of the sale item, and the registered price of the sale item. In addition, the status information on the sale item may include information indicating “on sale,” “completion of sale,” “expiration of sale,” and “waiting for sale.”

For example, when there is no sale item registered in holding slots, a guide message showing how to register sale items may be displayed. For example, a message 805 may be displayed which states, “Please register an item for sale by touching an item in the right inventory.”

For example, the first user may select a predetermined item from a list of items and may register the selected item as an item for sale (sale item).

For example, if sale items are registered in all of the registration slots, a sale slot purchase interface may be highlighted. For example, when sale items are registered in all of ten registration slots allocated to the first user, the button 807 for purchasing registration slots may be displayed in a predetermined color.

FIG. 8B is a view illustrating an item of which the sale period has expired and items waiting for sale among sale items, according to an example embodiment.

Referring to FIG. 8B, when the registration period of a first sale item has expired, the registration expiration date of the first sale item may be displayed as “expired 811” on a list of sale items, and a button 813 for re-registration may be displayed. For example, when the first user presses the button 813, the first sale item may be registered under the same sale condition as the previous sale condition. Alternatively, the first user may reset the sale condition for the first sale item.

In addition, when a second sale item is in a sale standby state 812, the registration expiration date of the second sale item may not be displayed in the list of sale items, and status information on the second item may be displayed as “waiting for sale.”

FIG. 8C is a view illustrating a process of purchasing a registration slot in which an item may be registered, according to an example embodiment.

Referring to FIG. 8C, a registration slot purchase button 821 may be provided on a sales interface. When sale items are registered in all registration slots which the first user possesses, the first user may press the registration slot purchase button 821 to purchase a registration slot and may register a predetermined item in the registration slot as a sale item.

For example, the color of the button 821 may be changed based on at least one selected from the group consisting of a user's sales performance and a user's status information.

For example, when sale items are registered in all the registration slots that the first user possesses, the button 821 may be displayed in a first color. The button 821 displayed in the first color may induce the first user to purchase a registration slot.

For example, when the sales performance of the first user exceeds a predetermined sales performance level, the button 821 may be displayed in a second color. The button 821 displayed in the second color may have a function of informing the first user that the number of registration slots in which the first user may register sale items has increased.

For example, when there is an item of which the frequency of use by the first user is less than a predetermined reference frequency of use, the button 821 may be displayed in a third color. The button 821 displayed in the third color may have a function of informing the first user that there is an item available for sale among items of the first user. For example, such a low-frequency item may be automatically included in an item list and may be indicated with a mark showing that the low-frequency item is a sellable item.

FIG. 8D is a view illustrating a process of preselling an item, according to an embodiment.

Referring to FIG. 8D, when a “bowl of ramen” registered as a sale item is not available for sale, the “bowl of ramen” may be displayed with an indicator “sale reservation” 831 on a sale item list.

For example, when the first user acquires a “bowl of ramen” in the first game, the “bowl of ramen” may be displayed as being available for sale on a sale item list in the market.

For example, an interface for setting a sale reservation for an item registered in a predetermined registration slot may be displayed on a sales interface. For example, a sales reservation icon for selecting a sale reservation may be displayed. When the first user selects a sale reservation icon for a first item, a sale reservation function may be executed for the first item.

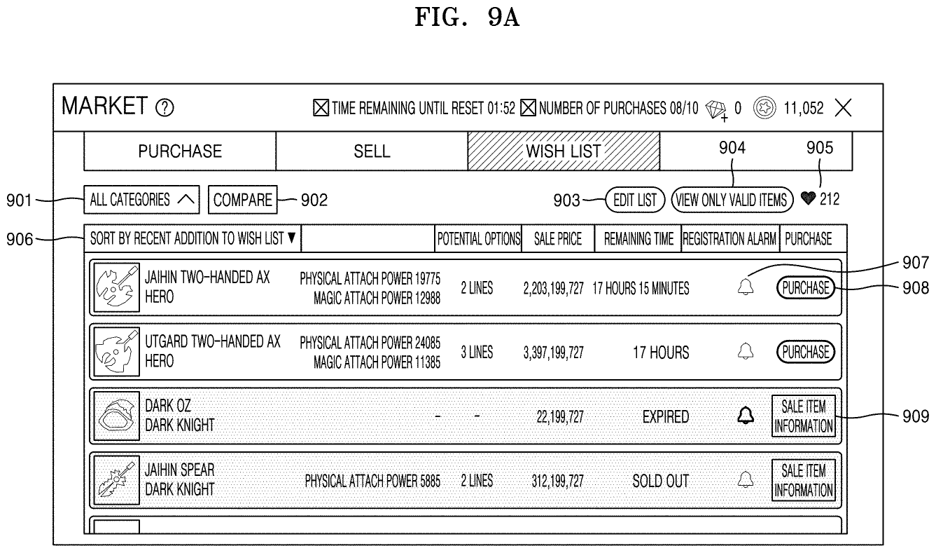

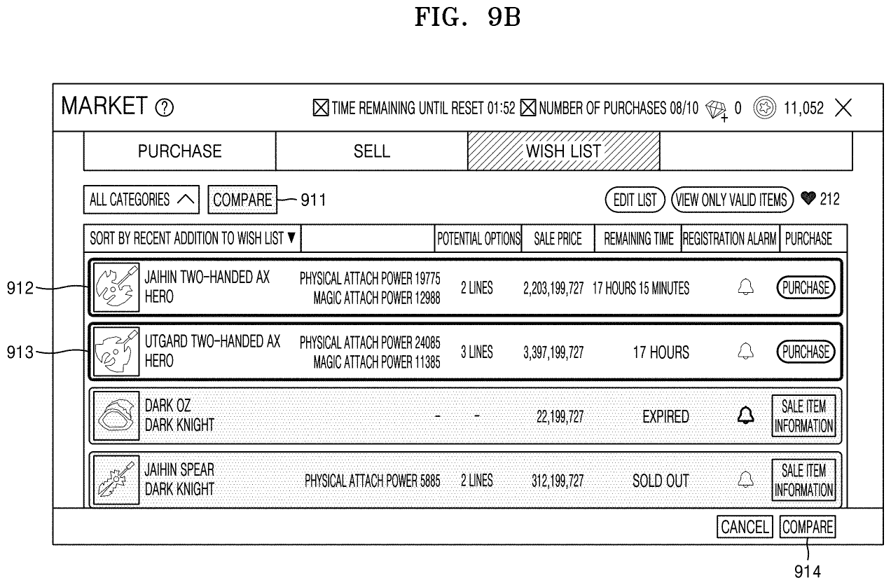

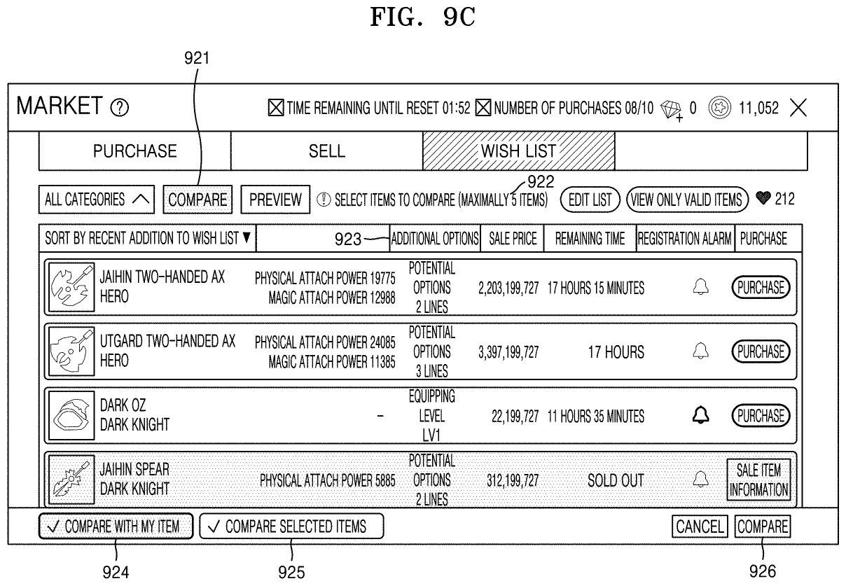

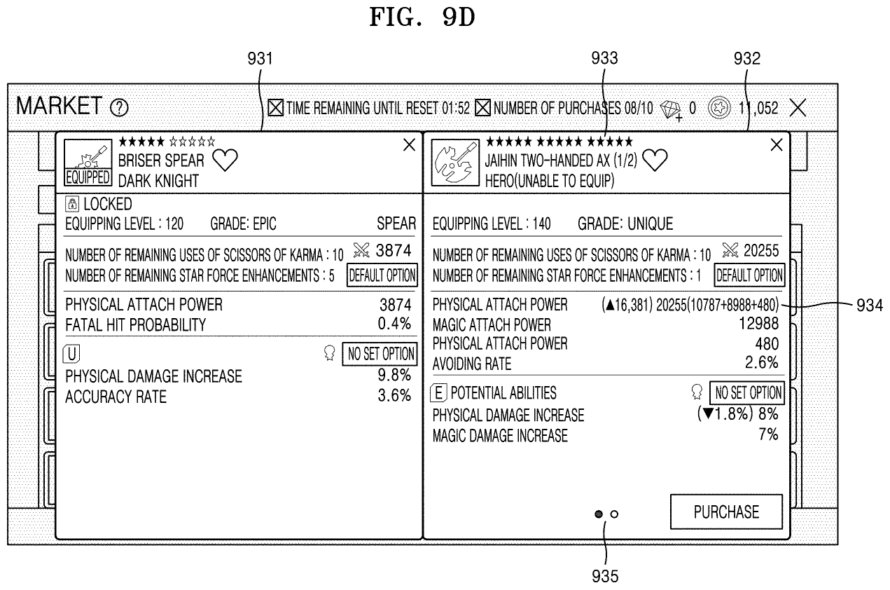

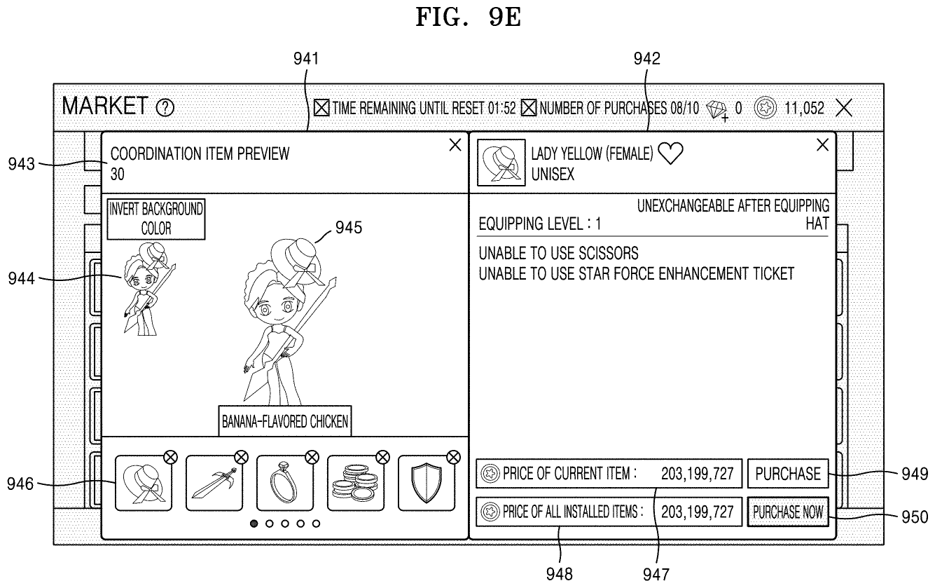

FIG. 9A is a view illustrating an execution screen showing items registered by a user as items of interest (interest item), according to an embodiment.

Referring to FIG. 9A, when the first user presses a wish list tab, a wish list interface may be displayed. The wish list interface may provide: a button 901 for selecting an item category; a button 902 for activating comparison; a button 903 for editing a wish list; a button 904 for viewing only valid items; information 905 on the number of items registered in the wish list; information 906 on the wish list; an indicator 907 for indicating registration in the market; a purchase button 908; a button 909 for requesting information on an item of interest registered in the wish list; and the like.

For example, when the first user presses the button 901 for selecting an item category, selectable item categories may be displayed.

For example, when the first user presses the button 902 for activating comparison and selects two items, information on results of comparison between given entries of the selected items may be displayed.

For example, when the first user presses the button 903 for editing the wish list, a setting window for editing the wish list may be displayed.

For example, the wish list of the first user may distinguishably show selectable items and non-selectable items. For example, the non-selectable items may be items that are not purchasable due to expiration or out-of-stock. For example, the non-selectable items may be shaded on the wish list.

For example, when the first user presses the button 904 for viewing only valid items, items which are not purchasable due to expiration or out-of-stock may be excluded, and only purchasable items may be arranged and displayed.

For example, when “Jaihin two-handed ax” is registered with the market, the indicator 907 may be displayed in a second color changed from a first color.

For example, when the first user presses a purchase button 908, a purchase window may be displayed as a guide to the purchase of a selected item of interest.

For example, when an item of interest of the first user is not registered with the market, a sale item information button 909 may be displayed instead of a purchase button. When the first user presses the sale item information button 909, information on the item of interest may be displayed.

FIG. 9B is a view illustrating a process in which a user compares items selected from items of interest, according to an example embodiment.

Referring to FIG. 9B, the first user may select a first interest item 912 and a second interest item 913 from the wish list in a state in which a compare button 911 is activated. When the first user presses a comparison button 914, results of comparison between the first interest item 912 and the second interest item 913 may be displayed.

Here, when the first interest item 912 and the second interest item 913 are included in the same category or have the same function, it is possible to compare the first interest item 912 and the second interest item 913 with each other. For example, when the first interest item 912 and the second interest item 913 are included in different categories and do not have a common function, a message indicating that comparison is impossible may be displayed.

In addition, two or more items may be compared with each other. For example, when two items of interest are selected, results of comparison between the two items of interest may be displayed. When three or more items of interest are selected, it is required to set a reference item and items to be compared with the reference item may be set among the items of interest. Accordingly, when three or more items of interest are selected, it may be requested to set a reference item among the selected item of interest.

FIG. 9C is a view illustrating a process of comparing an item that a user possesses with an item of interest of the user, according to an embodiment.

Referring to FIG. 9C, the first user may select a first interest item from the wish list in a state in which a compare button 921 is activated. When the first user presses a compare button 924 for comparison with my item and a compare button 926, results of comparison between a first holding item which the first user possesses and a first interest item in which the first user is interested may be displayed. A screen displaying results of comparison between the first holding item and the first interest item will be described with reference to FIG. 9D. For example, an item that the first user possesses may be an item that the first user possesses with the account of the first user in the first game, or may be an item with which the first character of the first user is currently equipped. For example, results of comparison between an item with which the first character of the first user is equipped and an item on the wish list may be displayed.

For example, the first user may select a first interest item and a second interest item from the wish list in a state in which the compare button 921 is activated. When the first user presses the compare button 925 for comparison between selected items and the compare button 926, results of comparison between the first interest item and the second interest item may be displayed.

In addition, comparing the execution screen illustrated in FIG. 9B with the execution screen illustrated in FIG. 9C, the wish list interface may additionally provide information 922 on the number of comparable items and additional information 923 on the items of interest on the wish list.

FIG. 9D is a view illustrating results of comparison between an item that a user possesses and an item of interest of the user, according to an example embodiment.

Referring to FIG. 9D, results of comparison between a first holding item which the first user possesses and a first interest item in which the first user is interested may be displayed. For example, an execution screen 931 containing detailed information on the first holding item may be displayed. In addition, an execution screen 932 containing detailed information on the first interest item may be displayed.

For example, results of comparison between the first holding item and the first interest item may be displayed on the execution screen 932. For example, information 934 on results of comparison in the numerical value of physical attack power or the numerical value of physical damage increase among potential abilities may be displayed. For example, an increase or decrease in numerical value may be expressed with an exact value or in a percentage.

In addition, information 933 on the number of items to be compared with the first holding item and page information 935 on comparison items may also be displayed on the execution screen 932. For example, the first interest item may be a first comparison item among two items of interest.

FIG. 9E is a view illustrating a process of purchasing an item of interest that has been previewed, according to an example embodiment.

Referring to FIG. 9E, before purchasing a predetermined item, the first user may preview the predetermined item. When previewing is executed, an execution screen 941 showing a preview of an item of interest and an execution screen 942 containing detailed information on the item of interest may be displayed.

For example, the execution screen 941 showing the preview may provide: information 943 on the number of items of interest which are selected on the preview; an equipped state view 944 which is adjusted to an in-game size; an enlarged equipped state preview 945; and a list 946 of items that can be previewed.

The first user may select all or some of previewed items of interest and may purchase the selected items of interest. The execution screen 942 may display: money information 947 on an item with which a character is most recently equipped in the preview; and money information 948 on all items with which the character is equipped in the preview. In addition, the execution screen 942 may also display: a purchase button 949 for purchasing the item with which the character is most recently equipped; and an instant purchase button 950 for purchasing all the items with which the character is equipped in the preview.

FIG. 10 is a block diagram illustrating a configuration of the electronic device 10 according to an embodiment.

Referring to FIG. 10, the electronic device 10 may include a communication device 1010, a user interface device 1020, a memory 1030, and a processor 1040. However, not all of the illustrated components are essential components. The electronic device 10 may be implemented by more components than the illustrated components, or by fewer components than the illustrated components. Hereinafter, the components of the electronic device 10 will be described.

The communication device 1010 may communicate with external devices. For example, the communication device 1010 may be connected to a network in a wired or wirelessly manner for communication with external devices. Here, the external devices may include servers, smartphones, tablets, or PCs. The communication device 1010 may include a communication module which supports one of various wired and wireless communication methods. For example, the communication module may be in the form of a chipset, a sticker/barcode (e.g., a sticker including an NFC tag) including information necessary for communication, or the like. In addition, the communication module may be a short-range communication module or a wired communication module.

For example, the communication device 1010 may support at least one selected from the group consisting of wireless LAN (wireless LAN), Wi-Fi, Wi-Fi direct (WFD), Bluetooth, BLE, wired LAN, near field communication (NFC), Zigbee, infrared data association (IrDA), 3G, 4G, and 5G.

The user interface device 1020 may refer to a device that receives data from a user to control the electronic device 10. The processor 1040 may control the user interface device 1020 to generate and output a user interface screen for receiving a predetermined command or data from a user. The user interface device 1020 may include: an input device configured to receive an input or the like for controlling the operation of the electronic device 10; and an output device configured to display information such as results of operations of the electronic device 10 or the state of the electronic device 10. For example, the input device may include a mouse, a joystick, an operation panel, or a display panel that displays a screen.

For example, the input device may include devices capable of receiving various types of user inputs, such as a keyboard, physical buttons, a mouse, a joystick, a touch screen, a camera, or a microphone. In addition, the output device may include, for example, a display panel or a speaker. However, embodiments are not limited thereto, and the user interface device 1020 may include a device supporting various types of inputs and outputs.

The memory 1030 may store software or programs. The memory 1030 may store a program or application of the market that provides a transaction service for game items. In addition, the memory 1030 may store at least one program for executing a method of operating the electronic device 10 such that a program or application of the market may be executed. At least one program stored in the memory 1030 may be divided into a plurality of modules according to functions.

The processor 1040 may control the overall operation of the electronic device 10 and may include at least one processor such as a CPU. The processor 1040 may include at least one specialized processor corresponding to each function, or may be an integrated type of processor.

The processor 1040 may execute a program stored in the memory 1030, read data or files stored in the memory 1030, or store a new file in the memory 1030. The processor 1040 may execute instructions stored in the memory 1030. For example, the processor 1040 may execute the program or application of the market installed on the electronic device 10 and may process events occurring while the program or application of the market is executed.

The processor 1040 may execute a market that provides a transaction service for trading of items of a first game. For example, the “market” may be a system provided to allow a user to purchase or sell items of the first game.

In addition, the program or application corresponding to the market may be executed independently of a program or application corresponding to the first game. In addition, information on a first event that occurred in the market may be transmitted to the server that manages the first game. The server, which manages the first game, may transmit information on the first event that occurred in the market to the electronic device 10, which executes the first game, and may provide an environment reflecting the first event in the first game. In addition, information on a second event that occurred in the first game may be transmitted to the server that manages the market. The server, which manages the market, may transmit the information on the second event that occurred in the first game to the electronic device 10, which executes the first game, and may provide an environment reflecting the second event in the market.

That is, because an event that occurred in the market is linked to the first game, status information on a first user may be updated in the first game. In addition, because an event that occurred in the first game is linked to the market, status information on the first user may be updated in the market.

For example, the term “item” may refer to an article, a product, content, or the like that may be used in a game. For example, items may refer to equipment, auxiliary equipment, accessories, coordination, or consumables such as weapons, armor, or costumes which may be put on a game character.

The processor 1040 may display a first execution screen on the user interface device 1020 based on status information on the first user in the first game such that at least one item of the first game may be purchased using the first execution screen.

For example, when the market is executed on the electronic device 10, the communication device 1010 may obtain status information on the first user from the server that manages the first game. The user interface device 1020 may display the first execution screen which contains a list of at least one item corresponding to the status information on the first user.

For example, the status information on the first user may include at least one selected from the group consisting of a first character played by the first user in the first game, the level of the first user in the first game, the quest of the first user in the first game, and the game progress status of the first user in the first game.

For example, based on the first character played by the first user and the level of the first user, the processor 1040 may search for items available for the first character and the level of the first user and may display the first execution screen including a list of found items on the user interface device 1020.

For example, the processor 1040 may display, on the user interface device 1020, an interface through which at least one entry, which corresponds to status information on the first user and is considered in searching for particular items of the first game, is selectable. The user interface device 1020 may display the first execution screen based on a first entry selected from one or more entries.

For example, the user interface device 1020 may display a first button indicating the first character played by the first user in the first game, a second button indicating the level of the first user, a third button indicating the quest of the first user, and a fourth button indicating a hunting ground in the first game on which the first user plays the first game. The user interface device 1020 may receive an input selecting the first button and the third button among the first to fourth buttons. The processor 1040 may search for items necessary for the first character of the first user to accomplish the quest of the first user, and may display the first execution screen including a list of found items on the user interface device 1020.

For example, the user interface device 1020 may receive an input for calling up a first search criterion among a plurality of search criteria which define at least one selected from the group consisting of a condition for searching for items of the first user's interest and a condition for sorting results of the search. The user interface device 1020 may display a list in which one or more items are rearranged based on the first search criterion.

For example, the plurality of search criteria may be stored in advance in the account of the first user. When the market is executed with the account of the first user, the user interface device 1020 may receive an input for calling up the first search criterion among the plurality of search criteria. For example, a predetermined search criterion may be called up when a user presses a button corresponding to the predetermined search criterion or enters an input corresponding to the predetermined search criterion. For example, a touch may be set as an input for calling up the first search criterion, and two consecutive touches may be set as an input for calling up a second search criterion.

For example, the processor 1040 may search for items based on the called-up search criterion and may display a list of found items on the user interface device 1020. In addition, the processor 1040 may determine the order of priority of previously found items based on the called-up search criterion, and may display, on the user interface device 1020, a list in which the items are rearranged according to the order of priority.

For example, the user interface device 1020 may display the first execution screen that contains a list of one or more items arranged based on status information on the first user. Here, the list may include information on the suitability of each of the one or more items for the first user.

For example, when the first user plays the first game on a first hunting ground using the first character, the processor 1040 may search for items in the market based on the first hunting ground. The user interface device 1020 may display a list in which items are arranged based on the first character. Here, when there is a second item in the list that cannot be put on the first character, the user interface device 1020 may display information indicating that the second item cannot be put on the first character. In addition, the items in the list may be sorted based on the order of suitability of the items for the first character.

The user interface device 1020 may receive an input for selecting the first item from the first execution screen or a screen generated based on the first execution screen.

For example, the user interface device 1020 may receive the first search criterion which defines at least one selected from the group consisting of a condition for searching for items of interest on the first execution screen and a condition for sorting search results on the first execution screen. The processor 1040 may display, on the user interface device 1020, a first search result obtained based on the first search criterion. The user interface device 1020 may receive an input for selecting the first item from the first search result.

For example, a condition for searching for an item of interest may define at least one selected from the group consisting of a user's character, a user's level, a category of the item of interest, and the price of the item of interest. In addition, a condition for sorting search results may define at least one parameter based on which the priority of the item of interest is determined. For example, the at least one parameter may include the attack power, defense ability, or price of the item of interest.

In addition, the user interface device 1020 may display a second execution screen which contains an interface providing information on the price of the first item and information on comparison between items. The user interface device 1020 may receive an input for selecting price information or comparison information from the second execution screen. The user interface device 1020 may display detailed information on the first item based on an input for selecting price information or comparison information.

In addition, the processor 1040 may compare an item which the first user possesses with an item of the first user's interest and may display results of the comparison on the user interface device 1020. For example, the item of the first user's interest may be an item stored in a wish list or a shopping cart. In addition, the item of the first user's interest may be an item selected by the first user. For example, the item which the first user possesses and the item of the first user's interest may be compared with each other in at least one comparison entry selected from the group consisting of physical attack power, accuracy rate, damage increase rate, and use period. The electronic device 10 may display results of comparison between the item that the first user possesses and the item of the first user's interest in terms of the at least one comparison entry.

In addition, when the selected first item is an expired or sold-out item, the processor 1040 may display, on the user interface device 1020, a second item as a substitute for the first item based on status information on the first user. For example, an item, which has the same function as the first item and can be put on the first character of the first user, may be determined as a substitute for the first item. However, an item, which has the same function as the first item but cannot be put on the first character of the first user, may not be determined as a substitute for the first item. In addition, when there are a plurality of items that can be substituted for the first item, the user interface device 1020 may arrange and display substitute items based on a predetermined criterion for arranging a plurality of items.

When the processor 1040 receives an input for purchasing the first item, the processor 1040 may purchase the first item.

For example, the user interface device 1020 may display a purchase interface through which at least one selected from previewed items of interest may be purchased. For example, the user interface device 1020 may receive an input for selecting the first item through the purchase interface, and the processor 1040 may perform an operation of purchasing the first item. After the first item is purchased with the account of the first user through the market, the first user may possess the first item in the first game through a linkage between the market and the first game.

In addition, when it is determined that the difference between options of a first holding item which the first user possesses and options of a first interest item in which the first user is interested is greater than a predetermined criterion, the processor 1040 may guide purchasing of the first interest item. Here, the first interest item and the first holding item may belong to the same category.

The electronic device 10 described above may be implemented using a hardware component, a software component, and/or a combination thereof. For example, the devices and components illustrated in the embodiments may be implemented using one or more general-purpose or special-purpose computers, such as, a processor, a controller, an arithmetic logic unit (ALU), a digital signal processor, a microcomputer, a field programmable gate array (FPGA), a programmable logic unit (PLU), a microprocessor or any other device capable of responding to and executing instructions. A processing device may run an operating system (OS) and one or more software applications that run on the OS. The processing device also may access, store, manipulate, process, and create data in response to execution of the software. For purpose of simplicity, the case of using only one processing device may be described; however, one skilled in the art will appreciated that a processing device may include multiple processing elements and/or multiple types of processing elements. For example, a processing device may include multiple processors or may include a processor and a controller. In addition, different processing configurations are possible, such as parallel processors.

The software may include a computer program, a piece of code, an instruction, or one or more combinations thereof, to independently or collectively instruct or configure the processing device to operate as desired. Software and/or data may be embodied permanently or temporarily in any type of machine, component, physical or virtual equipment, or computer storage medium or device, or in a propagated signal wave in order to provide instructions or data to the processing device or to be interpreted by the processing device. The software may also be distributed over network coupled computer systems so that the software is stored and executed in a distributed fashion. The software and data may be stored in one or more non-transitory computer readable recording mediums.

The methods according to the embodiments may be realized as program instructions implemented by various computers and be recorded in non-transitory computer-readable media. The non-transitory computer-readable media may include, alone or in combination with the program instructions, data files, data structures, and the like. The program instructions recorded in the media may be designed and configured specially for the embodiments or be known and available to those skilled in computer software. Examples of the non-transitory computer-readable recording media may include magnetic media such as hard disks, floppy disks, and magnetic tape; optical media such as CD ROMs and DVDs; magneto-optical media such as floptical disks; and hardware devices that are specially configured to store and perform program instructions, such as read-only memory (ROM), random access memory (RAM), flash memory, and the like. Examples of program instructions include both machine codes, such as produced by a compiler, and high-level language codes that may be executed by a computer using an interpreter. The described hardware devices may be configured to act as one or more software modules in order to perform the operations of the above-described example embodiments, or vice versa.

As described above, according to the one or more of the above embodiments, users may smoothly search for desired items and may receive results of the search for the desired items.

According to the one or more embodiments, transaction environments for promoting item trading between users may be provided.

According to the one or more embodiments, detailed information on items that users want may be provided.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of operating an electronic device, the method comprising:
executing a market providing a transaction service which enables trading of items of a first game;
based on status information on a first user in the first game, displaying a first execution screen through which at least one item of the first game is purchasable;
receiving an input for selecting a first item through the first execution screen or an execution screen generated based on the first execution screen; and
when an input for purchasing the first item is received, purchasing the first item.

2. The method of claim 1, wherein the displaying of the first execution screen based on the status information on the first user comprises:
acquiring the status information on the first user from a server which manages the first game; and
displaying the first execution screen which comprises a list of the at least one item corresponding to the status information on the first user.

3. The method of claim 1, wherein the status information on the first user comprises at least one selected from the group consisting of a first character with which the first user plays the first game, a level of the first user in the first game, a quest of the first user in the game, and a game progress status of the first user in the first game.

4. The method of claim 1, wherein the displaying of the first execution screen based on the status information on the first user comprises:
displaying an interface through which at least one entry is selectable, the at least one entry corresponding to the status information on the first user and considered in searching for a predetermined item of the first game; and
displaying the first execution screen based on a first entry selected from the at least one entry.

5. The method of claim 1, wherein the receiving of the input for selecting the first item comprises:
receiving information on a first search criterion which defines at least one selected from the group consisting of a condition for searching for an item of interest on the first execution screen and a condition for arranging results of a search on the first execution screen;
displaying a first search result obtained according to the information on the first search criterion; and
receiving an input for selecting the first item from the first search result.

6. The method of claim 1, further comprising:
displaying a second execution screen which comprises an interface providing information on a market price of the first item and information on comparison between items;
receiving an input for selecting the information on the market price or the information on the comparison through the second execution screen; and
displaying detailed information on the first item based on the input for selecting the information on the market price or the information on the comparison.

7. The method of claim 1, wherein the displaying of the first execution screen comprises:
receiving an input for calling up information on a first search criterion from information on a plurality of search criteria which define at least one selected from the group consisting of a condition for searching for an item of interest of the first user and a condition for arranging results of a search; and
displaying a list in which the at least one item is rearranged based on the information on the first search criterion.

8. The method of claim 1, wherein
the displaying of the first execution screen comprises displaying the first execution screen which comprises a list of the at least one item arranged based on the status information on the first user, and
the list comprises information indicating suitability of a first character of the first user for each of the at least one item.

9. The method of claim 1, further comprising comparing an item that the first user possesses and an item of interest of the first user with each other.

10. The method of claim 1, further comprising comparing an item with which a first character of the first user is equipped and an item included in a wish list of the first user with each other; and displaying results of the comparison.

11. The method of claim 1, further comprising distinguishably displaying selectable items and non-selectable items of a wish list of the first user.

12. The method of claim 1, wherein when the first item is an expired item or an out-of-stock item, the method further comprises displaying a second item as a substitute for the first item based on the status information on the first user.

13. The method of claim 1, further comprising guiding purchasing of a first interest item in which the first user is interested when it is determined that a difference between an option of the first interest item of the first user and an option of a first holding item of the first user, which belongs to a common category together with the first interest item of the first user, is greater than a given criterion.

14. The method of claim 1, wherein, when the input for purchasing the first item is received, the purchasing of the first item comprises displaying a purchase interface through which at least one item of interest selected from previewed items of interest is purchasable.

15. The method of claim 1, wherein
the transaction service comprises a service allowing a user to sell items using a preset number of sale slots provided in the market, and
the method further comprises providing a sales interface which comprises a sale slot purchase interface through which at least one sale slot is additionally purchasable.

16. The method of claim 15, wherein the providing of the sales interface comprises at least one selected from the group consisting of:
highlighting the sale slot purchase interface when items are registered in the preset number of sale slots; and
providing the sales interface for setting a sale reservation for an item registered in a sale slot.

17. The method of claim 1, further comprising
providing a sales interface for selling a predetermined item based on at least one selected from the group consisting of sales performance of the first user and the status information on the first user,
wherein the providing of the sales interface comprises:
displaying the sales interface in which an allowable registration range of the first user is adjusted based on the sales performance of the first user;
guiding selling, through the sales interface, an item of which a frequency of use by the first user is less than a preset criterion; and
guiding selling of the predetermined item through the sales interface based on status information on the market and the status information on the first user.

18. A computer program stored in a non-transitory medium for executing a method of operating an electronic device in combination with the electronic device, wherein the method comprises:
executing a market providing a transaction service which enables trading of items of a first game;
based on status information on a first user in the first game, displaying a first execution screen through which at least one item of the first game is purchasable;
receiving an input for selecting a first item through the first execution screen or an execution screen generated based on the first execution screen; and
when an input for purchasing the first item is received, purchasing the first item.

19. A non-transitory computer-readable recording medium having recorded thereon a program for executing the method of claim 1.

20. An electronic device comprising:
a communication device;
a user interface device;
a processor; and
a memory storing instructions executable by the processor,
wherein the processor executes the instructions to:
execute a market providing a transaction service which enables trading of items of a first game;
display a first execution screen, through which at least one item of the first game is purchasable, on the user interface device based on status information on a first user in the first game;
receive, through the user interface device, an input for selecting a first item on the first execution screen or an execution screen generated based on the first execution screen; and
purchase the first item when an input for purchasing the first item is received through the user interface device.
